(19) United States
(12) Patent Application Publication
(10) Pub. No.: US 2010/0062204 A1
(43) Pub. Date: Mar. 11, 2010

(54) PRESSURE-SENSITIVE ADHESIVE FILM FOR ADHERING TO WHEEL

(75) Inventors: Atsuhiro Tanaka, Itabashi-ku (JP); Atsushi Tezuna, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Lintec Corporation, Itabashi-ku, Tokyo (JP)

(21) Appl. No.: 12/530,735

(22) PCT Filed: Mar. 7, 2008
(86) PCT No.: PCT/JP2008/054694

§ 371 Date: Sep. 10, 2009

(30) Foreign Application Priority Data
Mar. 13, 2007 (JP) 2007-063992

(51) Int. Cl. B32B 3/02

(52) U.S. Cl. 428/66.6

(57) ABSTRACT

The present invention provides a pressure-sensitive adhesive film for adhering on a wheel which comprises a substrate film and a pressure-sensitive adhesive layer formed on one surface of the substrate film, and has a ring adhesive strength of 80 N or greater at one hour after the adhering, wherein the ring adhesive strength at one hour after the adhering indicates the exhibited maximum load as determined in a manner, which comprises adhering the pressure-sensitive adhesive film being circular with a diameter of 100 mm by means of the pressure-sensitive adhesive layer on a ring shaped coated aluminum frame of 100 mm outer diameter, 90 nm inner diameter and 5 mm width in an atmosphere of 23° C. and 50% RH, and pressing by means of a 2 kg roll, and next, making a hole of 2 mm diameter in the center of the circular pressure sensitive adhesive film, and then, inserting a shaft of a circular flat plate with shaft having a shaft of 2 mm diameter perpendicular erected on the center of a circular flat plate of 80 mm diameter into the hole, subsequently adhering the circular pressure sensitive adhesive film to the surface of the circular flat plate, and allowing to stand still in an atmosphere of 23° C. and 50% RH for one hour, and horizontally fixing the ring shaped coated aluminum frame with the adhered circular pressure sensitive adhesive film placed upside, and then lifting the shaft of the circular flat plate with shaft having the circular pressure sensitive adhesive film adhered thereto in the direction of the shaft at a shaft lifting rate of 300 mm/min.

### TECHNICAL FIELD

The present invention relates to a pressure-sensitive adhesive film for adhering to a surface of a wheel of motor vehicle.

### BACKGROUND ART

A motor vehicle brake disc is arranged inside a wheel. However, the motor vehicle brake disc is oxidized by rainwater infiltrating from an opening of the wheel which is formed for radiating heat of the brake disc, and rust sticks thereto. If the motor vehicle is driven frequently, such rust of the brake disc is peeled by a brake pad and therefore, there is no problem.

However, if the rust is caused to the brake disc in the term of transporting the motor vehicle on a carrier car or keeping the motor vehicle prior to deliver the motor vehicle to an end user, it leads to decrease the reliability. Accordingly, it is necessary to prevent the brake disc from rusting until the motor vehicle is delivered from a factory to the end user.

Conventionally, for the purpose of preventing the rust on a motor vehicle brake disc, there has been adopted a method in which a molded pulp product which is called as a pulp mold is directly fitted on a brake disc.

However, such a molded pulp product is poor in water resistance, heat resistance and fire resistance because of the raw material characteristic, necessitates a number of steps for fitting and removing it, and is high in cost and suffers other disadvantages; accordingly, there has recently been proposed the substitution of such a molded pulp product with a pressure-sensitive adhesive film for adhering to the wheel (referred to Japanese Patent No. 2873910). Such a pressure-sensitive adhesive film is adhered to a surface of a tire wheel because the pressure-sensitive adhesive film has advantages such that it involves simple steps for adhesion and peeling and is capable of preventing the scratch of the tire wheel.

Recently, in view of the improvement of heat radiation efficiency, the pursuit of superior design and the like, the shape of the tire wheel becomes mainly spoke type tire wheels (pillar forms) instead of conventional dish type tire wheels (dish forms). Therefore, the area of the opening of the wheel increases.

Further, a recent motor vehicle chassis is aerodynamically designed, for the purpose of cooling the brake disc, in such a way that the air flow entering from the front of the motor vehicle is blown against the brake disc from below the body of the motor vehicle and sucked toward tire wheels while the motor vehicle is running. Consequently, an air pressure is exerted from the inside on the pressure-sensitive adhesive film adhered to outside of the wheel. Thus, there is a problem such that the pressure-sensitive adhesive film adhered to outside of the wheel is peeled off when a motor vehicle is being transported on a carrier car or when a finished motor vehicle is being subjected to a running test.

For solving the above described problem, there is a manner that the adhesive strength of the pressure-sensitive adhesive film is increased. However, for using applications of the product, it is necessary to peel off the adhered film inevitably. Therefore, if the adhesive strength is only increased simply, the pressure-sensitive adhesive film is inferior in peeling ability such that the residue of the pressure-sensitive adhesive is caused and it is difficult to peel off the adhesive film from the adherend. Thus, the adhesive film can hardly be used as the product.

Furthermore, for solving the above described problem, there is a suggested protecting film that a slitting is formed in a pressure-sensitive adhesive film to release the air pressure added inside of the wheel to outside of the wheel (referred to Japanese Patent publication No. 2005-155758A). However, such a suggestion can not shut out the adverse effect to the brake disc completely, because rainwater and pollutant are infiltrated from the slitting.

### DISCLOSURE OF THE INVENTION

### Problem to be Solved by the Invention

An object of the present invention is to provide, by solving the above described problems, a pressure-sensitive adhesive film used for adhering on a wheel which can be hardly peeled off when the pressure-sensitive adhesive film is adhered to a motor vehicle wheel, can prevent the rust of the brake disc and can be peeled off without the residue in peeling when the pressure-sensitive adhesive film is peeled off from the motor vehicle wheel.

### Means for Solving Problem

The present inventors have perfected the present invention by discovering, as a result of a diligent study carried out to solve the above described problems, that the above described problems can be solved by using a pressure-sensitive adhesive film for adhering to a wheel which comprises a substrate film and a pressure-sensitive adhesive layer formed on one surface of the substrate film, and has a ring adhesive strength of 80 N or greater at one hour after the adhering.

Specifically, the present invention provides a pressure-sensitive adhesive film for adhering to a wheel which comprises a substrate film and a pressure-sensitive adhesive layer formed on one surface of the substrate film, and has a ring adhesive strength of 80 N or greater at one hour after the adhering, wherein the ring adhesive strength at one hour after the adhering indicates the maximum value of exhibited load as determined in a manner, which comprises adhering the pressure-sensitive adhesive film being circular with a diameter of 100 mm by means of the pressure-sensitive adhesive layer on a ring shaped coated aluminum frame of 100 mm outer diameter, 90 mm inner diameter and 5 mm width in an atmosphere of 23° C. and 50% RH, and pressing by means of a 2 kg roll, and next, making a hole of 2 mm diameter in the center of the circular pressure sensitive adhesive film, and then, inserting a shaft of a circular flat plate with shaft having a shaft of 2 mm diameter perpendicular erected on the center of a circular flat plate of 80 mm diameter into the hole, subsequently adhering the circular pressure sensitive adhesive film to the surface of the circular flat plate, and allowing to stand still in an atmosphere of 23° C. and 50% RH for one hour, and horizontally fixing the ring shaped coated aluminum frame with the adhered circular pressure sensitive adhesive film placed upside, and then lifting the shaft of the circular flat plate with shaft having the circular pressure sensitive adhesive film adhered thereto in the direction of the shaft at a shaft lifting rate of 300 mm/min.

Additionally, the present invention provides the pressure-sensitive adhesive film for adhering to a wheel as described above, which comprises a substrate film and a pressure-sensitive adhesive layer formed on one surface of the substrate film, and has a ring adhesive strength of 85 N or greater at 24 hours after the adhering, wherein the ring adhesive strength at one hour after the adhering indicates the maximum value of exhibited load as determined in a manner, which comprises adhering the pressure-sensitive adhesive film being circular with a diameter of 100 mm by means of the pressure-sensitive adhesive layer on a ring shaped coated aluminum frame of 100 mm outer diameter, 90 nm inner diameter and 5 mm width in an atmosphere of 23° C. and 50% RH, and pressing by means of a 2 kg roll, and next, making a hole of 2 mm diameter in the center of the circular pressure sensitive adhesive film, and then, inserting a shaft of a circular flat plate with shaft having a shaft of 2 mm diameter perpendicular erected on the center of a circular flat plate of 80 mm diameter into the hole, subsequently adhering the circular pressure sensitive adhesive film to the surface of the circular flat plate, and allowing to stand still in an atmosphere of 23° C. and 50% RH for 24 hours, and horizontally fixing the ring shaped coated aluminum frame with the adhered circular pressure sensitive adhesive film placed upside, and then lifting the shaft of the circular flat plate with shaft having the circular pressure sensitive adhesive film adhered thereto in the direction of the shaft at a shaft lifting rate of 300 mm/min.

Additionally, the present invention provides the pressure-sensitive adhesive film for adhering to a wheel as described above, wherein the substrate film has Young's modulus (E) of 180 MPa or greater and coefficient of bending stress represented by the following formula (1) of 0.017 N·mm or greater.

k=Eh³ (1)

Wherein, in the formula, k is coefficient of bending stress, E is Young's modulus and h is a thickness of the substrate film.

Further, the present invention provides the pressure-sensitive adhesive film for adhering to a wheel as described above, wherein an adhesive strength measured by means of 180° peeling method in conformity with JIS Z0237 at 24 hours after adhering in an environment of 23° C. and 50% RH is 8.0 N/25 mm or lower.

### Effect of the Invention

The pressure-sensitive adhesive film for adhering to a wheel of the present invention, can be hardly peeled off and excellent in prevention of rust to be formed on a motor vehicle brake disc, when the surface of the pressure-sensitive adhesive layer is adhered to the wheel so as for the surface of the pressure-sensitive adhesive layer to face and touch the wheel, and can be peeled off without the residue in peeling when the pressure-sensitive adhesive film is peeled off from the motor vehicle wheel.

### BRIEF DESCRIPTION OF THE DRAWINGS

FIG. 1 shows a plane view of a coated aluminum frame used for measuring the ring adhesive strength;

FIG. 2 shows a conceptual plane view of a state that the pressure-sensitive adhesive film being circular is adhered to the coated aluminum frame used for measuring the ring adhesive strength, and further, the coated aluminum frame adhered with the pressure-sensitive adhesive film being circular is fitted with a circular flat plate with shaft;

FIG. 3 shows a conceptual cross-section of a state that the pressure-sensitive adhesive film being circular is adhered to the coated aluminum frame used for measuring the ring adhesive strength, and further, the coated aluminum frame adhered with the pressure-sensitive adhesive film being circular is fitted with a circular flat plate with shaft;

In drawings, 1 means a coated aluminum frame, 2 means a pressure-sensitive adhesive film being circular, 3 means a circular flat plate with shaft, and 4 means a shaft.

### PREFERRED EMBODIMENTS FOR CARRYING OUT THE INVENTION

The pressure-sensitive adhesive film for adhering to a wheel of the present invention has the ring adhesive strength at one hour after the adhering of 80 N or greater, preferably 85 N or greater, and more preferably 90 N or greater. In view of peeling ability, the upper limit of the ring adhesive strength at one hour after the adhering is 160 N, and preferably about 150 N.

Here, the ring adhesive strength at one hour after the adhering is explained based on drawings.

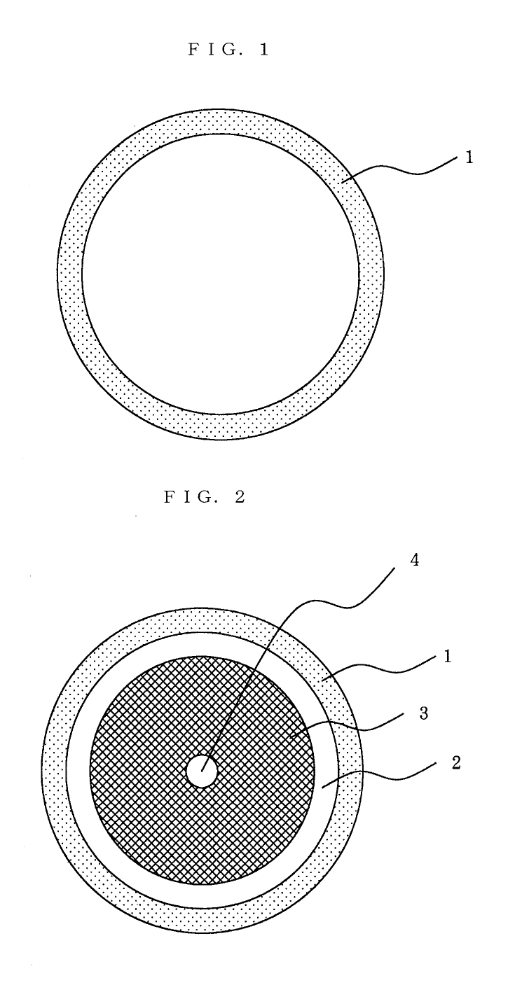

As shown in FIG. 1, first, a ring shaped coated aluminum frame 1 of 100 mm outer diameter, 90 nm inner diameter and 5 mm width is prepared. If the ring shaped coated aluminum frame 1 has a rigidity that the ring shaped coated aluminum frame 1 is not deformed during the measurement of the ring adhesive strength, the thickness of the ring shaped coated aluminum frame 1 particularly is not limited, but usually is preferably 3 to 20 mm. As a paint for applying on the ring shaped aluminum frame to prepare the ring shaped coated aluminum frame 1, an acrylic paint is used.

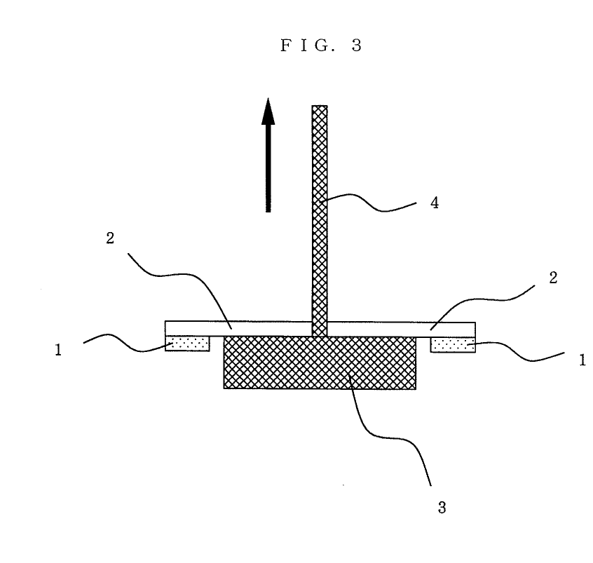

Second, the pressure-sensitive adhesive film 2 being circular with a diameter of 100 mm, which is made of the pressure-sensitive adhesive film for adhering to a wheel of the present invention, is adhered to the ring shaped coated aluminum frame 1 by means of the pressure-sensitive adhesive layer in an atmosphere of 23° C. and 50% RH, and is pressed by using a 2 kg roll in one reciprocating moving to adhere tightly. Next, as shown in FIG. 2, a hole of 2 mm diameter is made in the center of the circular pressure sensitive adhesive film 2, and then, a shaft 4 of a circular flat plate with shaft 3 having a shaft 4 of 2 mm diameter perpendicular erected on the center of a circular flat plate 3 of 80 mm diameter is inserted into the hole, subsequently the circular pressure sensitive adhesive film 2 is adhered to the surface of the circular flat plate 3 by using a squeegee. The circular flat plate 3 is made of various materials, usually made of metal, and preferably made of stainless steel in particular.

And then, as shown in FIG. 3, the circular flat plate 3 with the adhered circular pressure sensitive adhesive film 2 is allowed to stand still in an atmosphere of 23° C. and 50% RH for one hour, and the ring shaped coated aluminum frame 1 with the adhered circular pressure sensitive adhesive film 2 placed upside is horizontally fixed, and then the circular flat plate with shaft 3 having the circular pressure sensitive adhesive film 2 adhered thereto is lifted in the direction of the shaft 4 at a shaft lifting rate of 300 mm/min. The maximum value of exhibited load as determined in the above manner is the ring adhesive strength at one hour after the adhering. In FIG. 3, a device for fixing horizontally the ring shaped coated aluminum frame 1 having the circular pressure sensitive adhesive film 2 adhered thereto, is omitted.

The pressure-sensitive adhesive film for adhering to a wheel of the present invention has the ring adhesive strength at 24 hours after the adhering of 85 N or greater, preferably 90 N or greater, and more preferably 95 N or greater. In view of peeling ability, the upper limit of the ring adhesive strength at 24 hours after the adhering is 170 N, and preferably about 160 N.

Here, the ring adhesive strength at 24 hours after the adhering indicates the maximum value of exhibited load as determined in a manner, which comprises fitting the circular pressure sensitive adhesive film 2 and the circular flat plate with shaft 3 to the ring shaped coated aluminum frame 1, allowing to stand still the circular flat plate 3 with the adhered circular pressure sensitive adhesive film 2 in an atmosphere of 23° C. and 50% RH for 24 hours, and fixing horizontally the ring shaped coated aluminum frame 1 with the adhered circular pressure sensitive adhesive film 2 placed upside, and then lifting the circular flat plate with shaft 3 having the circular pressure sensitive adhesive film 2 adhered thereto in the direction of the shaft 4 at a shaft lifting rate of 300 mm/min, in the same manner as the ring adhesive strength at one hour after the adhering described above.

The pressure-sensitive adhesive film for adhering to a wheel of the present invention needs stiffness as the whole pressure-sensitive adhesive film to adhere the pressure-sensitive adhesive film having a large area onto the appointed place of the wheel. Therefore, the substrate film of the pressure-sensitive adhesive film for adhering to a wheel of the present invention has Young's modulus (E) of preferably 180 MPa or greater, more preferably 190 MPa or greater. The upper limit of Young's modulus is not limited, but preferably 400 MPa or lower, and more preferably 350 MPa or lower to obtain the followability to the curved surface of the wheel.

The pressure-sensitive adhesive film for adhering to a wheel of the present invention needs to prevent a deform of the pressure-sensitive adhesive film caused by the wind pressure. Therefore, the substrate film of the pressure-sensitive adhesive film for adhering to a wheel of the present invention has a coefficient of bending stress represented by the formula (1) described above of preferably 0.017 N·mm or greater, more preferably 0.020 N·mm or greater, and most preferably 0.023 N·mm or greater. The upper limit of coefficient of bending stress is not limited, but preferably 1.000 N·mm or lower to obtain the followability to the curved surface of the wheel.

As a substrate film of the pressure-sensitive adhesive film for adhering to a wheel of the present invention, various substrate films that exert the ring adhesive strength at one hour after the adhering described above can be used, and include films of various resins of polyolefin resin such as polyethylene resin and polypropylene resin; poly vinyl chloride resin; polyester resin such as polyethylene terephthalate resin and polyethylene naphthalate resin; polycarbonate resin; ethylene copolymer such as ethylene-propylene copolymer, ethylene-vinyl acetate copolymer and ionomer; thermoplastic polyolefin resin; thermoplastic polyester elastomer; and the like. From a viewpoint of superior flexibility and followability to the curved surface, polyethylene resin film is used preferably as a substrate film. The polyethylene resin includes preferably copolymer resins of ethylene as main component and at least one member selected from the group consisting of olefins, preferably a-olefins having carbon atoms of 6 to 16, preferably 6 to 12, such as 1-hexene, 1-heptene, 1-octene, 1-nonene, 1-decene and 1-dodecene. The olefin can be used in a combination of 2, 3, or 4 or more members.

A method for forming the substrate film includes convenient methods, and for example, a method which comprises extruding the raw material of the substrate film at melting point of 180 to 250° C. to form a film by means of T die process or inflation process, and then, quenching the film by means of roll cooling, air cooling or the like to wind up the film.

The substrate film can be subjected to a stretching treatment.

As a stretching process, various stretching processes are applied. Examples of such a stretching process include, for example, a MD uniaxial orientation process based on a group of rolls driven at different peripheral speed, a TD uniaxial orientation process based on tenter oven, a biaxial orientation process as a combination of these methods, and a tubular orientation process based on inflation.

The substrate film can be subjected to an annealing treatment after stretching.

No particular constraint is imposed on the thickness of the substrate film of the pressure-sensitive adhesive film for adhering to a wheel of the present invention, but the thickness is usually preferably 20 to 200 μm, and particularly preferably 30 to 100 μm.

It is preferable to contain an ultraviolet absorber in the substrate film of the pressure-sensitive adhesive film for adhering to a wheel of the present invention in such a way that the spectral transmittance of the substrate film in a wavelength region from 280 to 380 nm falls within a range from 0 to 20%. The containing ratio of the ultraviolet absorber is preferably 0.005 to 10 parts by mass relative to 100 parts by mass of the substrate film. The inclusion of the ultraviolet absorber improves the resistance to weather, and the film can be peeled off without leaving any pressure-sensitive adhesive deposit on the adherend even when exposed in outdoor over a long period of time.

Specific examples of the ultraviolet absorber include hydroquinone-based ultraviolet absorbers, salicylic acid-based ultraviolet absorbers, benzophenone-based ultraviolet absorbers, benzotriazole-based ultraviolet absorbers and cyanoacrylate-based ultraviolet absorbers.

These ultraviolet absorbers can be used each alone or in combinations of two or more thereof.

Additionally, one or more weather resistant agents such as a photostabilizer and an antioxidant can be appropriately included together with the ultraviolet absorber.

In the present invention, a pressure-sensitive adhesive layer is formed on the back surface of the substrate film.

Examples of the pressure-sensitive adhesive to be used for the pressure-sensitive adhesive layer include natural rubber-based pressure-sensitive adhesives, synthetic rubber-based pressure-sensitive adhesives, acrylic resin-based pressure-sensitive adhesives, polyvinylether resin-based pressure-sensitive adhesives, urethane resin-based pressure-sensitive adhesives and silicone resin-based pressure-sensitive adhesives. Specific examples of the synthetic rubber-based pressure-sensitive adhesives include styrene-butadiene rubber, isobutylene-isoprene rubber, polyisobutylene rubber, polyisoprene rubber, styrene-isoprene block copolymer, styrene-butadiene block copolymer, styrene-ethylene-butylene block copolymer and ethylene-vinyl acetate thermoplastic elastomer.

Specific examples of the acrylic resin-based pressure-sensitive adhesives include pressure-sensitive adhesives containing as a main component, copolymers of (meth)acrylic acid ester having alkyl group with carbon atoms of 8 or lower, and include the copolymers of (meth)acrylic acid ester such as methyl acrylate, ethyl acrylate, propyl acrylate, butyl acrylate, 2-ethylhexyl acrylate, methyl methacrylate, ethyl methacrylate and butyl methacrylate; and optionally one or more of the following copolymerizable monomers: hydroxy group-containing alkyl (meth)acrylates such as 2-hydroxyethyl acrylate, 2-hydroxypropyl acrylate, 3-hydroxypropyl acrylate, 3-hydroxybutyl acrylate and 4-hydroxybutyl acrylate; (meth)acrylic acids such as acrylic acid and methacrylic acid; vinyl esters such as vinyl acetate and vinyl propionate; cyano group-containing compounds such as acrylonitrile and methacrylonitrile; amide group-containing compounds such as acrylamide; and aromatic compounds such as styrene, vinylpyridine.

Specific examples of the polyvinylether resin-based pressure-sensitive adhesives include polyvinylether and polyvinylisobutylether. Specific examples of the urethane resin-based pressure-sensitive adhesives include pressure-sensitive adhesives obtained by adding a tackifier or a plasticizer in the reaction product of a polyol and a cyclic or chain isocyanate. Specific examples of the silicone resin-based pressure-sensitive adhesives include dimethylpolysiloxane. These pressure-sensitive adhesives can be used each alone or in combinations of two or more thereof.

Preferred among these pressure-sensitive adhesives are the acrylic resin-based pressure-sensitive adhesives. Particularly preferred are acrylic resin-based pressure-sensitive adhesives obtained by crosslinking acrylic copolymers with a crosslinking agent such as a polyisocyanate based crosslinking agent, an epoxy based crosslinking agent, an aziridine based crosslinking agent, and a chelate based crosslinking agent.

Examples of the polyisocyanate based crosslinking agent include tolylene diisocyanate (TDI), hexamethylene diisocyanate (HMDI), isophorone diisocyanate (IPDI), xylene diisocyanate (XDI), hydrogenated tolylene diisocyanate, diphenylmethane diisocyanate and the hydrogenated product thereof, polymethylenepolyphenyl polyisocyanate, naphthylene-1,5-diisocyanate, polyisocyanate prepolymer and polymethylolpropane modified TDI.

Examples of the epoxy based crosslinking agent include ethyleneglycol glycidyl ether, 1,6-hexanediol glycidyl ether, trimethylolpropane glycidyl ether, diglycidyl aniline, and diglycidyl amine.

Examples of the aziridine based crosslinking agent include 2,2-bishydroxymethyl butanol-tris[3-(1-aziridinyl)propionate], 4,4-bis(ethyleniminocarboxyamino)diphenyl methane, tris-2,4,6-(1-aziridinyl)-1,3,5-triazine, tris[1-(2-methyl)aziridinyl]phosphine oxide, and hexa[1-(2-methyl)aziridinyl]triphospha triazine.

Examples of the chelate based crosslinking agent include aluminum chelate and titanium chelate.

The crosslinking agent can be used each alone or in combinations of two or more thereof.

By controlling the crosslinking amounts of the polyisocyanate compounds, pressure-sensitive adhesive physical properties required for various wheels can be attained. The use amount of each of the polyisocyanate compounds is preferably 0.01 to 20 parts by mass relative to 100 parts by mass of an acrylic copolymer. The crosslinking agents described above can be used each alone or in combinations of two or more thereof.

An ultraviolet absorber can be contained in the pressure-sensitive adhesive layer in such a way that the spectral transmittance of the pressure-sensitive adhesive film for adhering to a wheel in a wavelength region from 280 to 380 nm falls within a range from 0 to 20%. The mixing ratio of the ultraviolet absorber is preferably 0.01 to 20% by mass relative to the resin component of the pressure-sensitive adhesive layer.

The ultraviolet absorber includes the ultraviolet absorbers described above.

Additionally, a tackifier, a softener, an antiaging agent, a filler and a colorant such as a dye or a pigment can be appropriately mixed in the pressure-sensitive adhesive layer. Examples of the tackifier include rosin-based resins, terpenephenol resins, terpene resins, aromatic hydrocarbon-modified terpene resins, petroleum resins, chmarone-indene resins, styrene-based resins, phenolic resins and xylene resins. Examples of the softener include process oils, liquid rubbers and plasticizers. Examples of the filler include silica, talc, clay and calcium carbonate.

No particular constraint is imposed on the thickness of the pressure-sensitive adhesive layer, but the thickness may usually be 5 to 100 μm, and is preferably 10 to 60 μm.

The pressure-sensitive adhesive layer may be formed by directly coating on one surface of the surface substrate film, or may be formed on one surface of the surface substrate film by bonding the surface of the pressure-sensitive adhesive layer of a release liner and the surface substrate film to each other, wherein the release liner has been prepared as a release liner with the pressure-sensitive adhesive layer formed by coating beforehand a pressure-sensitive adhesive on the releasing agent layer surface of the release liner and by drying the pressure-sensitive adhesive layer. No particular constraint is imposed on the method for forming the pressure-sensitive adhesive layer, and various methods can be adopted. Examples of such methods include methods for forming by coating with the following coaters and drying: an airknife coater, a blade coater, a bar coater, a gravure coater, a roll coater, a roll knife coater, a curtain coater, a die coater, a knife coater, a screen coater, a Mayer bar coater and a kiss coater.

From a viewpoint of peeling off the pressure-sensitive adhesive film adhered on the wheel without the residue of adhesive in peeling after a motor vehicle is being transported on a carrier car, the pressure-sensitive adhesive film for adhering to a wheel of the present invention has an adhesive strength measured by means of 180° peeling method in conformity with JIS 20237 at 24 hours after adhering in an environment of 23° C. and 50% RH (hereinafter, can be called as “180° peeling adhesive strength”) of preferably 8.0 N/25 mm or lower, more preferably 7.5 N/25 mm or lower, most preferably 7.0 N/25 mm or lower. The lower limit of the 180° peeling adhesive strength is preferably 3.0 N/25 mm or more, in view of followability, floating and peeling of the pressure-sensitive adhesive film to the wheel curved surface.

The surface of the pressure-sensitive adhesive layer is preferably covered with a release liner. Alternatively, without using a release liner, it is possible to impart releasing ability to the surface substrate film by coating a releasing agent on the surface of the surface substrate film, and roll the pressure-sensitive adhesive film thus obtained for storage. Thus, the surface of the pressure-sensitive adhesive layer can be protected.

As the release liner, any types may be used. Examples of the release liner include, for example, various paper materials such as wood free paper, clay coated paper, resin coated paper, and glassine paper; laminate papers which is laminated on the paper materials with a film of polyolefin resin such as'polyethylene resin and polypropylene resin; release substrates which is treated with fillers such as cellulose, starch, polyvinyl alcohol, and acryl-styrene resin; and films made of resins such as polyester and polypropylene.

There can be used a release liner in which the surface, to be bonded to the pressure-sensitive adhesive layer, of the substrate of the release liner is subjected to a release treatment, if needed.

In this case, typical examples of the release treatment include the formation of a releasing agent layer formed of a releasing agent such as an olefin resin, an olefin copolymer resin, a silicone-based resin, a long-chain alkyl based resin or a fluorine-based resin. Among these releasing agent, an olefin resin, a silicone-based resin, a long-chain alkyl based resin and a fluorine-based resin are preferable.

No particular constraint is imposed on the thickness of the release liner, and the thickness may be appropriately selected.

The pressure-sensitive adhesive film for adhering to a wheel of the present invention has a followability. Therefore, the pressure-sensitive adhesive film for adhering to a wheel of the present invention can be adhered and bonded easily to a wheel having a three-dimensional complex form, a wheel having a form of steep slope of, for example, 30 to 80 degree, particularly 40 to 80 degree of average inclination, or a wheel having a slender spoke.

### EXAMPLES

Hereinafter, specific description will be made on the present invention with reference to Examples. However, the present invention is not limited at all by these Examples.

### Example 1

(1) Preparation of a Surface Substrate Film

By mixing 0.01 parts by mass of an ultraviolet absorber which is a polymer of dimethyl succinate and 4-hydroxy-2,2,6,6-tetramethyl-1-pyperidine ethanol (trade name: Tinuvin 622LD, manufactured by Ciba Specialty Chemicals Corp.) in 100 parts by mass of a low density polyethylene resin having a density of 0.928 g/cm³, kneading the mixture with an extruder, and then using an inflation machine, a substrate film having a thickness of 50 μm and Young's modulus (E) of 200 MPa was prepared.

(2) Preparation of a Pressure-Sensitive Adhesive Film for Adhering to a Wheel (Hereinafter, Can be Called as “Pressure-Sensitive Adhesive Film”)

A mixture was prepared by adding 2.0 parts by mass of an isocyanate-based crosslinking agent (trade name: Coronate L, manufactured by Nippon Polyurethane Industry Co., Ltd., solid content:75% by mass) to 100 parts by mass of an acrylic copolymer composition (trade name: AS665, manufactured by Ipposha oil Industry Co., Ltd., solid content:40% by mass). The acrylic resin based pressure-sensitive adhesive consisting of the mixture thus obtained was applied so as for the coating amount after drying to be 25 μm, with an applicator, on one surface of a releasing agent layer of a release liner (trade name: SP-8R, manufactured by Lintec Corp.) and dried to form a dried pressure-sensitive adhesive layer, wherein the release liner (trade name: SP-8R, manufactured by Lintec Corp.) was a product obtained by coating a silicone as a releasing agent on one surface of a support made of a woodfree paper to form a release layer. Thereafter, the release layer of the release liner and the substrate film obtained by the above described (1) were bonded with a laminator to prepare a pressure-sensitive adhesive film.

### Example 2

A pressure-sensitive adhesive film was prepared in the same manner as in Example 1 except that the pressure-sensitive adhesive obtained by the following (3) was used as the pressure-sensitive adhesive.

(3) Preparation of a Pressure-Sensitive Adhesive

In a reaction apparatus equipped with a thermometer, a stirrer, a reflux condenser tube and a nitrogen gas introduction tube, 52 parts by mass of 2-ethylhexyl acrylate, 27 parts by mass of ethyl acrylate, 18 parts by mass of vinyl acetate, 3 parts by mass of acrylamide and 100 parts by mass of ethyl acetate were placed, and the mixture thus obtained was allowed to copolymerize in the presence of a polymerization initiator, namely, azobisisobutyronitrile, and then diluted with toluene to yield a solution of an acrylic resin having a weight average molecular weight of 700,000 (solid content:35% by mass).

To 100 parts by mass of the solution of an acrylic resin thus obtained, 1 part by mass of an isocyanate-based crosslinking agent (trade name: Coronate L, manufactured by Nippon Polyurethane Industry Co., Ltd., solid content:75% by mass) was added and mixed to prepare a pressure-sensitive adhesive.

### Example 3

A pressure-sensitive adhesive film was prepared in the same manner as in Example 1 except that the pressure-sensitive adhesive obtained by the following (4) was used as the pressure-sensitive adhesive.

(4) Preparation of a Pressure-Sensitive Adhesive

In a reaction apparatus equipped with a thermometer, a stirrer, a reflux condenser tube and a nitrogen gas introduction tube, 75 parts by mass of 2-ethylhexyl acrylate, 15 parts by mass of ethyl acrylate, 8 parts by mass of vinyl acetate, 2 parts by mass of acrylamide and 100 parts by mass of ethyl acetate were placed, and the mixture thus obtained was allowed to copolymerize in the presence of a polymerization initiator, namely, azobisisobutyronitrile, and then diluted with toluene to yield a solution of an acrylic resin having a weight average molecular weight of 700,000 (solid content:42% by mass).

To 100 parts by mass of the solution of an acrylic resin thus obtained, 1 part by mass of an isocyanate-based crosslinking agent (trade name: Coronate L, manufactured by Nippon Polyurethane Industry Co., Ltd., solid content:75% by mass) was added and mixed to prepare a pressure-sensitive adhesive.

### Example 4

A pressure-sensitive adhesive film was prepared in the same manner as in Example 1 except that the surface substrate film obtained by the following (5) was used as the surface substrate film.

(5) Preparation of a Surface Substrate Film

By mixing 0.05 parts by mass of an ultraviolet absorber which is a polymer of dimethyl succinate and 4-hydroxy-2,2,6,6-tetramethyl-1-pyperidine ethanol (trade name: Tinuvin 622LD, manufactured by Ciba Specialty Chemicals Corp.) in 100 parts by mass of a linear low density polyethylene resin having a density of 0.933 g/cm³, kneading the mixture with an extruder, and then using an tubular orientation forming machine, a substrate film having a thickness of 45 μm and Young's modulus (E) of 350 MPa was prepared.

### Comparative Example 1

A pressure-sensitive adhesive film was prepared in the same manner as in Example 1 except that the pressure-sensitive adhesive obtained by the following (6) was used as the pressure-sensitive adhesive.

(6) Preparation of a Pressure-Sensitive Adhesive

In a reaction apparatus equipped with a thermometer, a stirrer, a reflux condenser tube and a nitrogen gas introduction tube, 58.8 parts by mass of 2-ethylhexyl acrylate, 10 parts by mass of butyl acrylate, 30 parts by mass of methyl acrylate, 1.2 parts by mass of acrylic acid and 100 parts by mass of ethyl acetate were placed, and the mixture thus obtained was allowed to copolymerize in the presence of a polymerization initiator, namely, azobisisobutyronitrile, and then diluted with toluene to yield a solution of an acrylic resin having a weight average molecular weight of 700,000 (solid content:38% by mass).

To 100 parts by mass of the solution of an acrylic resin thus obtained, 5 part by mass of an aziridine-based crosslinking agent (trade name: BXX5172, manufactured by TOYO INK MFG. CO., LTD., solid content:2% by mass) was added and mixed to prepare a pressure-sensitive adhesive.

### Comparative Example 2

By mixing 35 parts by mass of a propylene random polymer resin and 5 parts by mass of a titanium dioxide in 60 parts by mass of a propylene homopolymer resin, kneading the mixture with an extruder, and then extruding from a T die, a substrate film having a thickness of 50 μm and Young's modulus (E) of 850 MPa was prepared.

A solution obtained by diluting a pressure-sensitive adhesive consisting of a polyisobutylene having a weight average molecular weight of 800,000 (trade name: Oppanol B80, manufactured by BASF SE.) with 30 parts by mass of toluene was applied so as for the coating amount after drying to be 20 μm, with an applicator, on one surface of the substrate film thus obtained and dried to form a dried pressure-sensitive adhesive layer. Thereafter, the release layer of the release liner and the substrate film were bonded with a laminator to prepare a pressure-sensitive adhesive film.

Measurements of Physical Properties of Pressure-Sensitive Adhesive Films

The surface substrate films and the pressure-sensitive adhesive films prepared in Examples and Comparative Example were subjected to the following measurement of 180° peeling adhesive strength, measurement of ring adhesive strength, high speed running test of motor vehicle and peeling test. The results thus obtained are shown in Table 1.

(1) Measurement of 180° Peeling Adhesive Strength

A coated aluminum plate is prepared by applying an acrylic based paint (trade name: ACRYONCLEAR, manufactured by Kuboko Paint Co., Ltd.) so as for the coating amount after drying to be 20 μm, on a aluminum plate treated with alumite, dried and baked at 150° C. for 40 minutes.

To the coated aluminum plate thus obtained, the test pieces having a size of 25 mm and 150 mm obtained from the pressure-sensitive adhesive films prepared in above described Examples and Comparative Example were adhered by pressing with a 2 kg roll in one reciprocating moving in an environment of 23° C. and 50% RH in conformity with JIS 20237. And, the test pieces adhered to the coated aluminum plate were allowed to stand still in an atmosphere of 23° C. and 50% RH for one hour, and then an adhesive strength measured by means of 180° peeling method was measured in an atmosphere of 23° C. and 50% RH. In the same manner as the 180° peeling adhesive strength after one hour of the standing, the test pieces adhered to the coated aluminum plate were allowed to stand still in an atmosphere of 23° C. and 50% RH for 24 hours, and then an adhesive strength measured by means of 180° peeling method was measured in an atmosphere of 23° C. and 50% RH.

(2) Measurement of Ring Adhesive Strength

A coated aluminum frame is prepared by treating a ring shaped aluminum frame of 100 mm outer diameter, 90 mm inner diameter, 5 mm width and 5 mm thickness with alumite, and then applying an acrylic based paint (trade name: ACRYONCLEAR, manufactured by Kuboko Paint Co., Ltd.) on the aluminum frame treated with alumite.

To the coated aluminum plate thus obtained, the pressure-sensitive adhesive film being circular with a diameter of 100 mm obtained from the pressure-sensitive adhesive films prepared in above described Examples and Comparative Example were adhered by pressing with a 2 kg roll in one reciprocating moving in an environment of 23° C. and 50% RH.

Next, a hole of 2 mm diameter is made in the center of the circular pressure sensitive adhesive film, and then, a shaft of a circular flat plate with shaft having a shaft of 2 mm diameter perpendicular erected on the center of a circular flat plate of 80 mm diameter is inserted into the hole, subsequently the circular pressure sensitive adhesive film is adhered to the surface of the circular flat plate by using a squeegee.

And then, the circular flat plate with the adhered circular pressure sensitive adhesive film is allowed to stand still in an atmosphere of 23° C. and 50% RH for one hour and 24 hours, and the ring shaped coated aluminum frame with the adhered circular pressure sensitive adhesive film placed upside is horizontally fixed, and then the shaft of the circular flat plate with shaft having the circular pressure sensitive adhesive film adhered thereto is lifted in the direction of the shaft at a shaft lifting rate of 300 mm/min. The maximum value of exhibited load as determined in the above manner is the ring adhesive strength.

(3) High Speed Running Test of Motor Vehicle

Each of the pressure-sensitive adhesive films prepared in above described Examples and Comparative Example was formed in a circular with a diameter of 44 cm and adhered to cover the surface of a spoke type aluminum wheel having a size of 17 inch (trade name: RACING RS PLUS M, manufactured by ENKEI Co.) at the room temperature. At 24 hours after adhering, a motor vehicle fitted with the tire wheel thus obtained was driven at a speed of 100 km/hour for 60 minutes and 150 km/hour for 60 minutes respectively and then the adhered pressure-sensitive adhesive film was observed to evaluate the state of peeling of the adhered pressure-sensitive adhesive film. When the peeling was not observed, it is shown as “no peeling”. When the peeling was observed, it is shown as “peeling”.

(4) Peeling Ability Test

The pressure-sensitive adhesive films prepared in above described Examples and Comparative Example were adhered to the coated aluminum plate prepared in measurement of 180° peeling adhesive strength, and were irradiated for 400 hours in a weather meter (trade name: Sunshine Super Long Life Weatherometer WEL-SUN-HCH, manufactured by Suga Test Instruments Co., Ltd.). And then, the pressure-sensitive adhesive films adhered to the coated aluminum plate were taken out from the weather meter and were peeled from the coated aluminum plate. The residue of the pressure-sensitive adhesive to the coated aluminum plate and the appearance of coated film were observed and evaluated on the basis of the following standards.
Good: There is not residue of the pressure-sensitive adhesive to the coated aluminum plate and the appearance of coated film was good.
Poor: There is residue of the pressure-sensitive adhesive to the coated aluminum plate and the appearance of coated film was not good.

TABLE 1

| | | | | | Comp. | Comp. |
|---|---|---|---|---|---|---|
| | Example 1 | Example 2 | Example 3 | Example 4 | Ex. 1 | Ex. 2 |
| peeling ability | good | good | good | good | good | good |
| 180° peeling adhesive | | | | | | |
| strength(N/25 mm) | | | | | | |
| after one hour of the standing | 4.9 | 6.3 | 4.0 | 4.7 | 4.2 | 5.0 |
| after 24 hours of the standing | 4.9 | 6.5 | 4.7 | 4.8 | 4.4 | 6.2 |
| Ring adhesive strength (N) | | | | | | |
| after one hour of the standing | 85 | 110 | 81 | 82 | 70 | 60 |
| after 24 hours of the standing | 93 | 118 | 85 | 89 | 73 | 70 |
| Substrate film | | | | | | |
| thickness (mm) | 0.05 | 0.05 | 0.05 | 0.045 | 0.05 | 0.05 |
| Young modulus (MPa) | 200 | 200 | 200 | 350 | 200 | 850 |
| coefficient k of bending | 0.025 | 0.025 | 0.025 | 0.032 | 0.025 | 0.106 |
| stress (N · mm) | | | | | | |
| Peeling at high-speed running of | | | | | | |
| motor vehicle | | | | | | |
| at 100 km/h | No | No | No | No | peeling | peeling |
| | peeling | peeling | peeling | peeling | | |
| at 150 km/h | peeling | No | peeling | peeling | peeling | peeling |
| | | peeling | | | | |

### INDUSTRIAL APPLICABILITY

The pressure-sensitive adhesive film for adhering to a wheel of the present invention can be adhered and bonded to various wheels, in particular, a wheel having a surface of a three-dimensional complex form, a wheel having a surface of a slender spoke.

1. A pressure-sensitive adhesive film for adhering on a wheel which comprises a substrate film and a pressure-sensitive adhesive layer formed to one surface of the substrate film, and has a ring adhesive strength of 80 N or greater at one hour after the adhering, wherein the ring adhesive strength at one hour after the adhering indicates the maximum value of exhibited load as determined in a manner, which comprises adhering the pressure-sensitive adhesive film being circular with a diameter of 100 mm by means of the pressure-sensitive adhesive layer on a ring shaped coated aluminum frame of 100 mm outer diameter, 90 mm inner diameter and 5 mm width in an atmosphere of 23° C. and 50% RH, and pressing by means of a 2 kg roll, and next, making a hole of 2 mm diameter in the center of the circular pressure sensitive adhesive film, and then, inserting a shaft of a circular flat plate with shaft having a shaft of 2 mm diameter perpendicular erected on the center of a circular flat plate of 80 mm diameter into the hole, subsequently adhering the circular pressure sensitive adhesive film to the surface of the circular flat plate, and allowing to stand still in an atmosphere of 23° C. and 50% RH for one hour, and horizontally fixing the ring shaped coated aluminum frame with the adhered circular pressure sensitive adhesive film placed upside, and then lifting the shaft of the circular flat plate with shaft having the circular pressure sensitive adhesive film adhered thereto in the direction of the shaft at a shaft lifting rate of 300 mm/min.

2. The pressure-sensitive adhesive film for adhering to a wheel as claimed in claim 1, which comprises a substrate film and a pressure-sensitive adhesive layer formed on one surface of the substrate film, and has a ring adhesive strength of 85 N or greater at 24 hours after the adhering, wherein the ring adhesive strength at one hour after the adhering indicates the maximum value of exhibited load as determined in a manner, which comprises adhering the pressure-sensitive adhesive film being circular with a diameter of 100 mm by means of the pressure-sensitive adhesive layer on a ring shaped coated aluminum frame of 100 mm outer diameter, 90 mm inner diameter and 5 mm width in an atmosphere of 23° C. and 50% RH, and pressing by means of a 2 kg roll, and next, making a hole of 2 mm diameter in the center of the circular pressure sensitive adhesive film, and then, inserting a shaft of a circular flat plate with shaft having a shaft of 2 mm diameter perpendicular erected on the center of a circular flat plate of 80 mm diameter into the hole, subsequently adhering the circular pressure sensitive adhesive film to the surface of the circular flat plate, and allowing to stand still in an atmosphere of 23° C. and 50% RH for 24 hours, and horizontally fixing the ring shaped coated aluminum frame with the adhered circular pressure sensitive adhesive film placed upside, and then lifting the shaft of the circular flat plate with shaft having the circular pressure sensitive adhesive film adhered thereto in the direction of the shaft at a shaft lifting rate of 300 mm/min.

3. The pressure-sensitive adhesive film for adhering to a wheel as claimed in claim 1, wherein the substrate film has Young's modulus (E) of 180 MPa or greater and coefficient of bending stress represented by the following formula (1) of 0.017 N·mm or greater.
k=Eh³ (1)
Wherein, in the formula, k is coefficient of bending stress, E is Young's modulus and h is a thickness of the substrate film.

4. The pressure-sensitive adhesive film for adhering to a wheel as claimed in claim 1, wherein an adhesive strength measured by means of 180° peeling method in conformity with JIS 20237 at 24 hours after adhering in an environment of 23° C. and 50% RH is 8.0 N/25 mm or lower.
